(19) United States
(12) Patent Application Publication
(10) Pub. No.: US 2009/0075663 A1
(43) Pub. Date: Mar. 19, 2009

(54) Graphically based representations of equipment status, for example, wireless cell site alarms

(76) Inventor: Stephen L. Wilson, Cocoa Beach, FL (US)

Correspondence Address: PATTI , HEWITT & AREZINA LLC, ONE NORTH LASALLE STREET, 44TH FLOOR, CHICAGO, IL, 60602, US

(21) Appl. No.: 12/148,099

(22) Filed: Apr. 16, 2008

Related U.S. Application Data
(60) Provisional application No. 60/994,419, filed on Sep. 19, 2007.

(51) Int. Cl. H04Q 7/20

(52) U.S. Cl. 455/446

(57) ABSTRACT

An apparatus in one example has: a plurality of cell sites, each cell site having a respective cell number; a display of all cell sites of the plurality of cell sites regardless of cell numbers; each cell site being displayed with a respective indicator of a plurality of indicators, the plurality of indicators having at least a first indicator that represents a normal cell site and a second indicator that indicates an abnormal cell site; and the display having a graphical background on which the cell sites are depicted as a function of respective locations of the cell sites. Displaying the operational status of cell sites based on their geographical location and providing the technician with a method to quickly determine anomalies at a given site reduces analysis and fault resolution times.

### TECHNICAL FIELD

The invention relates generally to telecommunication systems, and more particularly to telecommunication systems having a plurality of cells.

### BACKGROUND

Cell site status is currently displayed on technician interface screens that are sorted by cell site numbers. An example is depicted in FIG. 1, which depicts cell site status. A technician must first note any cell with an abnormal status, such as cell 330 depicted in red, on the system level screen 100 then change to subsequent lower level screens to determine the specific anomaly. This “drill down” approach is unintuitive and time consuming.

Cell site numbers typically have no correlation to their physical location, such as cell site 359 is not adjacent to 360. An anomaly affecting multiple cell sites in a specific area may not be easily recognized by the technician since the affected sites status indication may be on different screens or not displayed in a cluster. Mission critical time is required to analyze abnormal cell site status from additional technician interface screens for a cell or cells to realize a common fault.

### SUMMARY

One implementation encompasses an apparatus. This embodiment of the apparatus may comprise: a plurality of cell sites, each cell site having a respective cell number; a display of all cell sites of the plurality of cell sites regardless of cell numbers; each cell site being displayed with a respective indicator of a plurality of indicators, the plurality of indicators having at least a first indicator that represents a normal cell site and a second indicator that indicates an abnormal cell site; and the display having a graphical background on which the cell sites are depicted as a function of respective locations of the cell sites.

Another implementation encompasses a method. This embodiment of the method may comprise: displaying, regardless of cell numbers, all cell sites of a plurality of cell sites, each cell site having a respective cell number; displaying each cell site with a respective indicator of a plurality of indicators, the plurality of indicators having at least a first indicator that represents a normal cell site and a second indicator that indicates an abnormal cell site; and displaying a graphical background on which the cell sites are depicted as a function of respective locations of the cell sites, the graphical background being a map on which the cell sites are depicted according to their actual geographical locations.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts a cell site status as is known in the art.

FIG. 2 depicts a Status and Display Page 2121.

FIG. 3 depicts cell site 16 SDP 2131.

FIG. 4 depicts a cell site 16 SDP 2138 for CDM2.

FIG. 5 depicts a cell site 16 SDP 2139 for CDM2.

FIG. 6 displays all cell sites on a map regardless of cell numbers

FIG. 7 depicts a graphic display of a cell site with a pop-up window and with a map in the background.

FIG. 8 depicts a map with cell site status.

FIG. 9 depicts a map with cell site status and a pop-up window.

FIG. 10 depicts another map with cell site status.

FIG. 11 is a general flow diagram depicting the present method.

### DETAILED DESCRIPTION

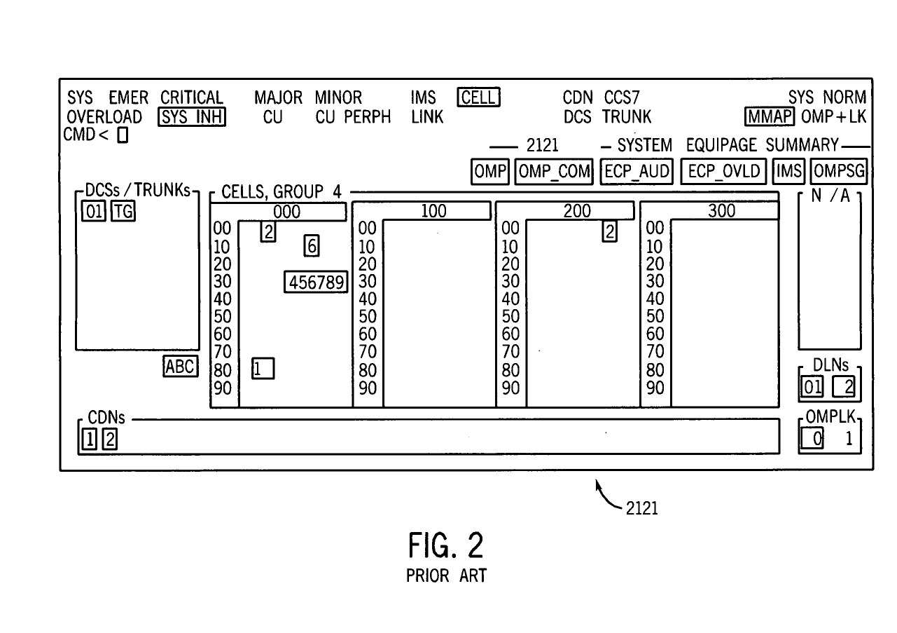

FIG. 2 depicts a Status and Display Page 2121. A technician responsible for monitoring cell site status currently reviews Status and Display page (SDP) 2121 which is a high level status page displaying cells in clusters based on the cell site number. The SDP 2121 is displaying cell sites 1 through 399. Additional group SDP 2121 pages are available for displaying cell site numbers greater than 399. In FIG. 2 cell sites 2, 16, 35, 81, and 82 have an abnormal status since their background color is red.

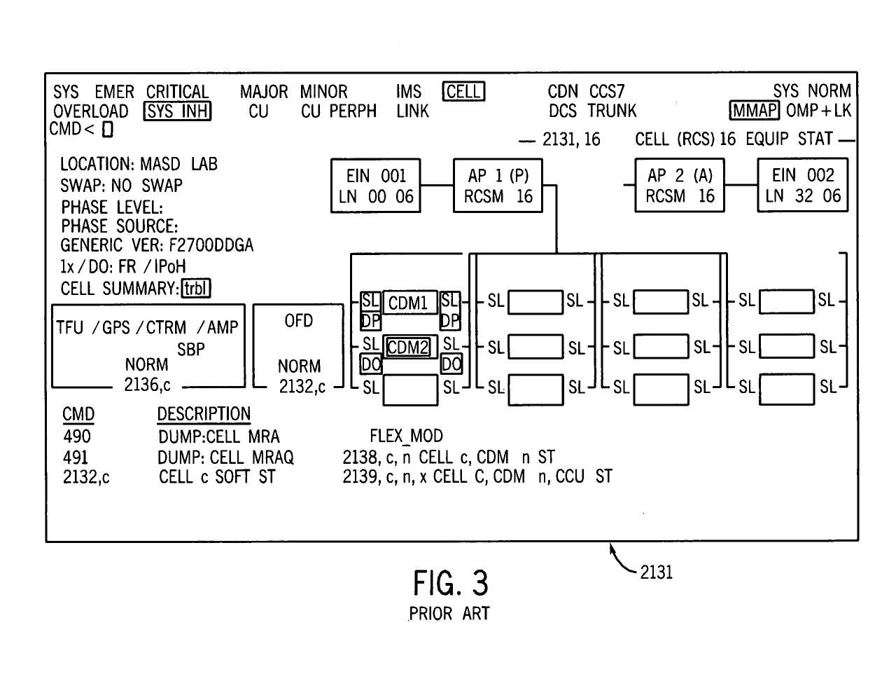

The technician uses additional SDPs to “drill down” and determine what alarm(s) are on a given cell. For example, to determine cell site 16's anomaly, the technician changes to cell 16's SDP 2131. FIG. 3 depicts cell site 16 SDP 2131. In FIG. 3 “CDM2” is indicated as being abnormal since it is displayed in the color red.

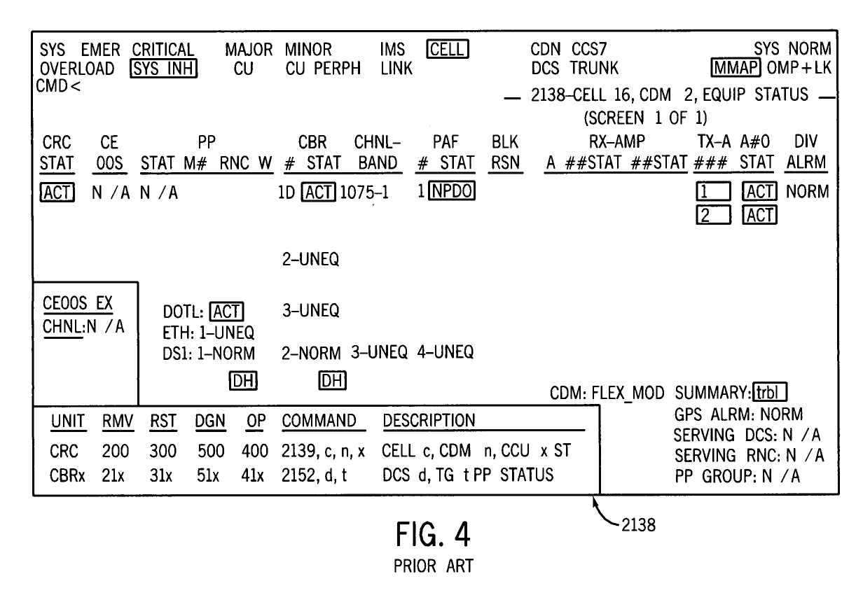

The technician would then change to SDP 2138 to display the CDM2 status. FIG. 4 depicts a cell site 16 SDP 2138 for CDM2. Although the SDP 2138 indicates the “PAF” is off normal, this is not the actual alarm for this cell site.

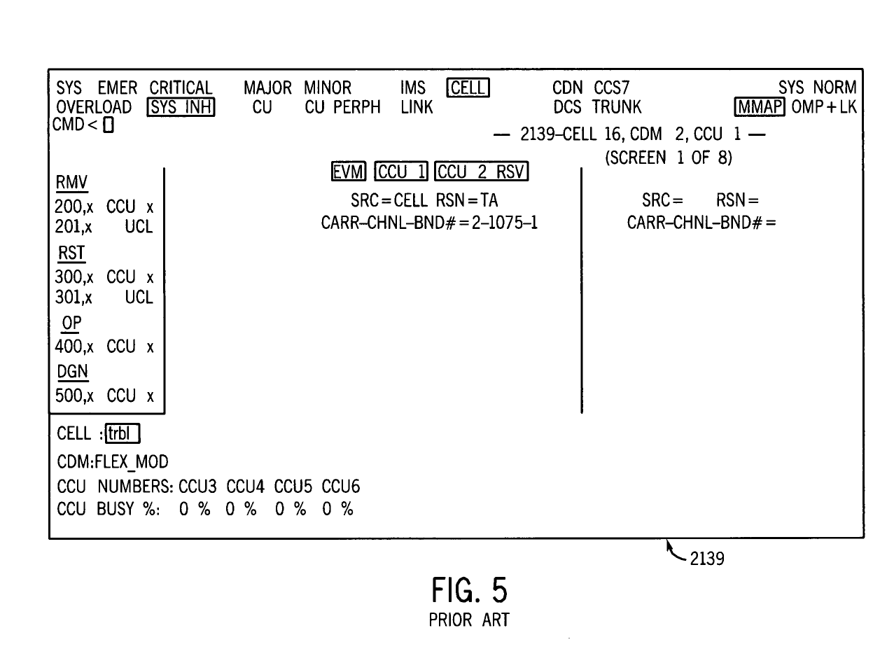

The technician must then change to additional SDPs to find the actual alarm. In this example, SDP 2139 for CDM2 is reviewed. FIG. 5 depicts a cell site 16 SDP 2139 for CDM2. In FIG. 5 it is indicated that “EVM CCU1” is out of service and the technician takes appropriate action to resolve the alarm. Similar steps are used to determine anomalies for the other cell sites as first noted on SDP 2121. This “drill down” approach is unintuitive and time consuming.

Cell site numbers typically have no correlation to their physical location, for example cell site 81 may not be adjacent to cell site 82. The technician may not easily recognize an anomaly affecting multiple cell sites in a specific area since the affected sites status indication may be on different screens or not displayed in a cluster. Mission critical time is required to analyze abnormal cell site status from additional technician interface screens for a cell or cells to realize a common fault.

Embodiments of the present method and apparatus addresses this issue by displaying the operational status of cell sites based on their geographical location and providing the technician with a method to quickly determine anomalies at a given site. Mission critical time to resolve anomalies is reduced by the reducing analysis time.

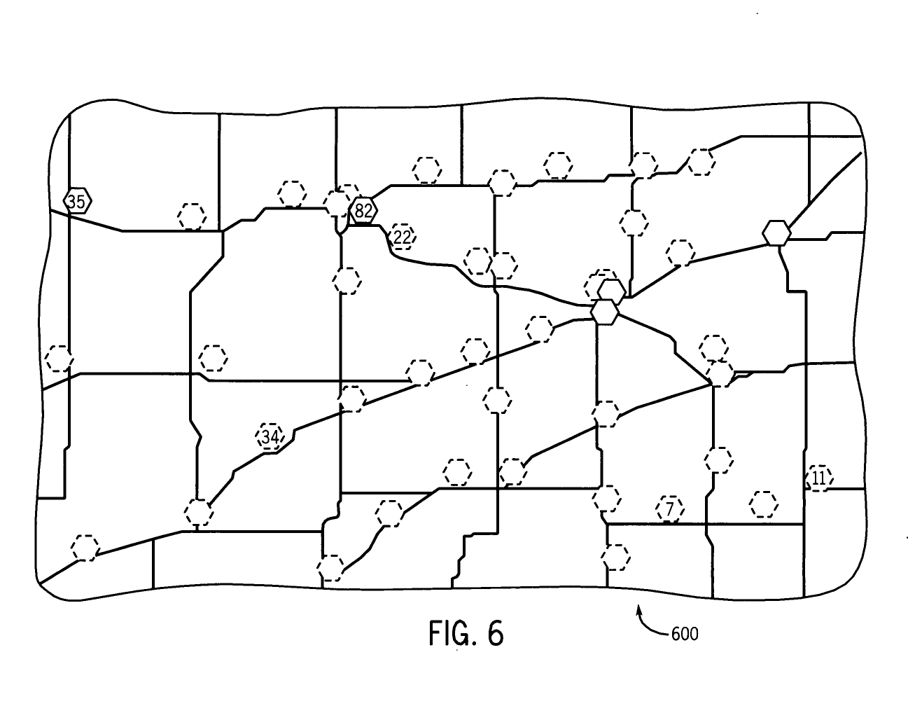

FIG. 6 depicts a graphic display of cell sites. The, Graphically Based Representations of Equipment Status is shown for analyzing the same anomalies as using SDPs. The example SDP 2121 does not show the same set of cell sites shown on the graphic display since the screen snap shots were taken from two different systems. All cells on the graphic display would be seen on the example SDP 2121 if they were taken from the same system since all cell sites numbers are less than 399.

FIG. 6 displays all cell sites on a map 600 regardless of cell numbers and avoids having to refer to subsequent high-level pages to see which cells have anomalies. In FIG. 6 the cell sites that are operational are depicted in green, while those having an anomaly are depicted in red, such as cell sites 2, 16, 35, 81, and 82. The status can be shown using any suitable means, including colors, flashing graphics, size, or any other means to show a difference between sites that are fully operational and those that are currently experiencing an anomaly.

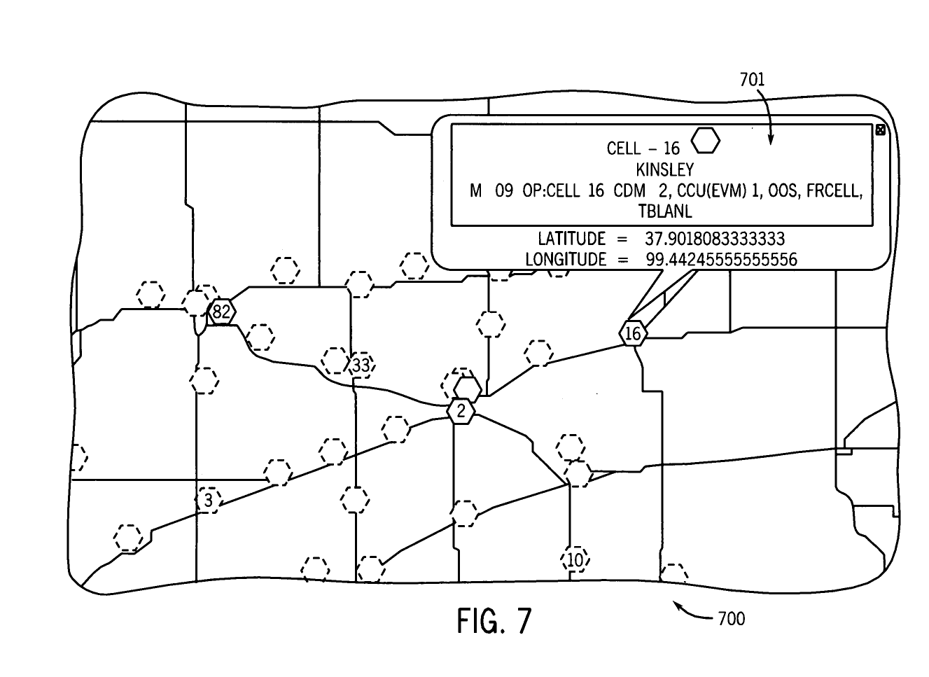

“Clicking on” cell 16's icon results in the depiction of FIG. 7. FIG. 7 depicts a graphic display of a cell site 16 with a pop-up window 701 and with a map 700 in the background. The pop-up window 701 indicates the, “CDM 2, CCU EVM” as out of service (OOS) in addition to the cell site name. Clicking on any cell site's icon displays their respective alarms.

Cell sites 2 and 81 are geographically adjacent although they are not adjacent sequentially based on cell site numbers. The anomalies on these two sites could be the result of a common factor, which would be quickly recognized using the graphic display as compared to the SDP “drill down” method. In the SDP “drill down” method the common factor would not be readily apparent.

The current technician interface implementation using SDPs requires the technician to note cell site status from several screens depending on the cell site number. The specific cell site fault is determined from additional screens that require a hierarchical “drill down” approach, such as system level to cell site level to cell site element level. This solution graphically displays the cell site system level based on geographical location. The specific cell site fault(s) are displayed by simply “clicking on” the site. Graphically displaying cell sites based on their location also allows the technician to quickly realize that a specific area or cluster of cells are being affected by a common fault regardless of their cell site numbers.

Although this example is specific to cell sites, this present method and apparatus may be used to display other equipment status that is geographically diverse. For example, the equipment may be of the type used in computer networking equipment, railroad crossing signals/gates, traffic signals, electrical power systems/grids, etc. Another example is in the field of navigational aids (NAVAID). Embodiments of the present method and apparatus enable improved performance determining which NAVAIDs are “off normal” in a geographical area.

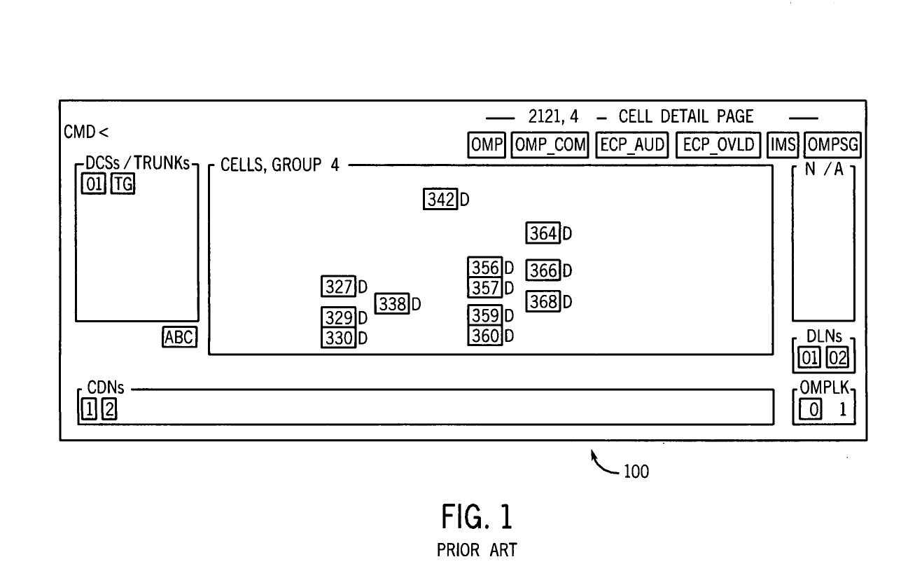

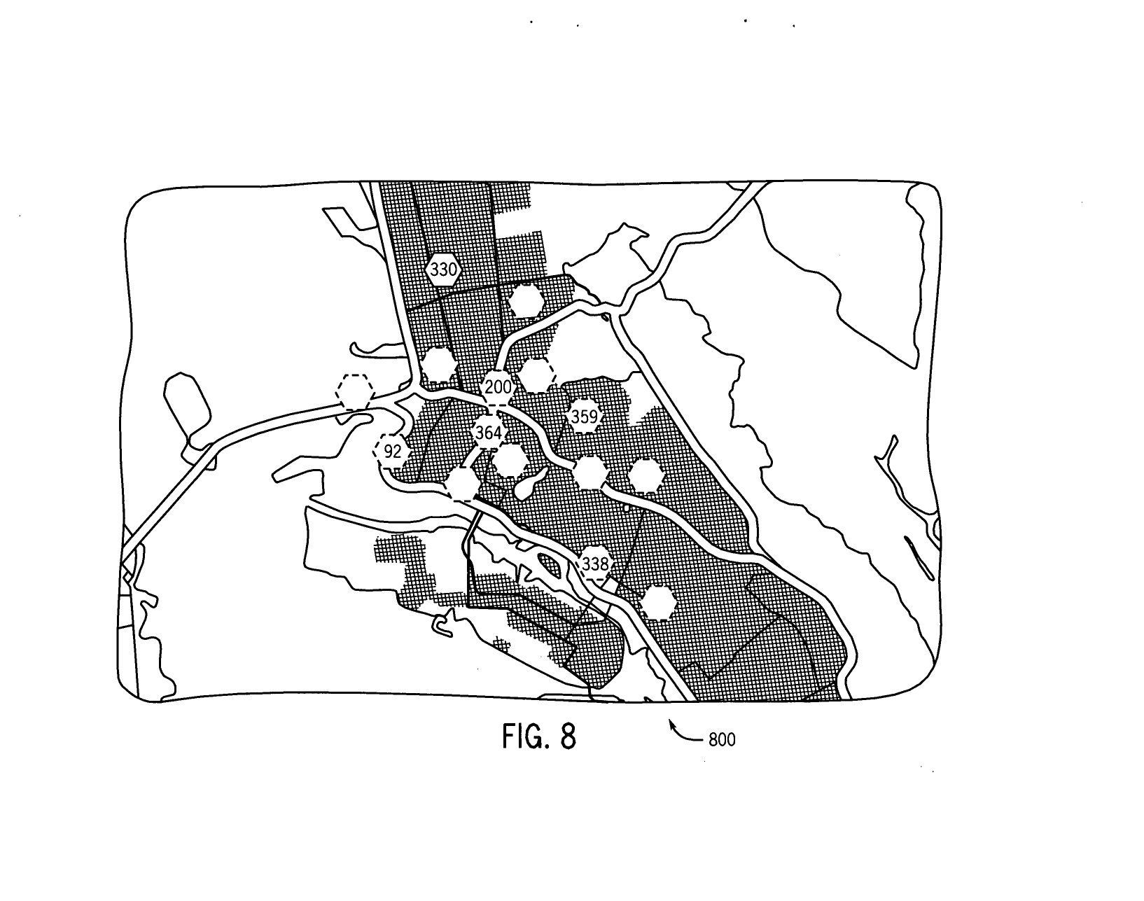

Displaying the operational status of cell sites based on their geographical location and providing the technician with a method to quickly determine anomalies at a given site reduces analysis and fault resolution times. The example in FIG. 8 displays all cell sites including those not shown on the screen in FIG. 1, since the FIG. 1 specific screen only displays cell site numbers in the range of 301-400. Although this example is specific to cell sites, the solution can be used to display other equipment status that is geographically diverse. FIG. 8 depicts a map 800 with cell site status.

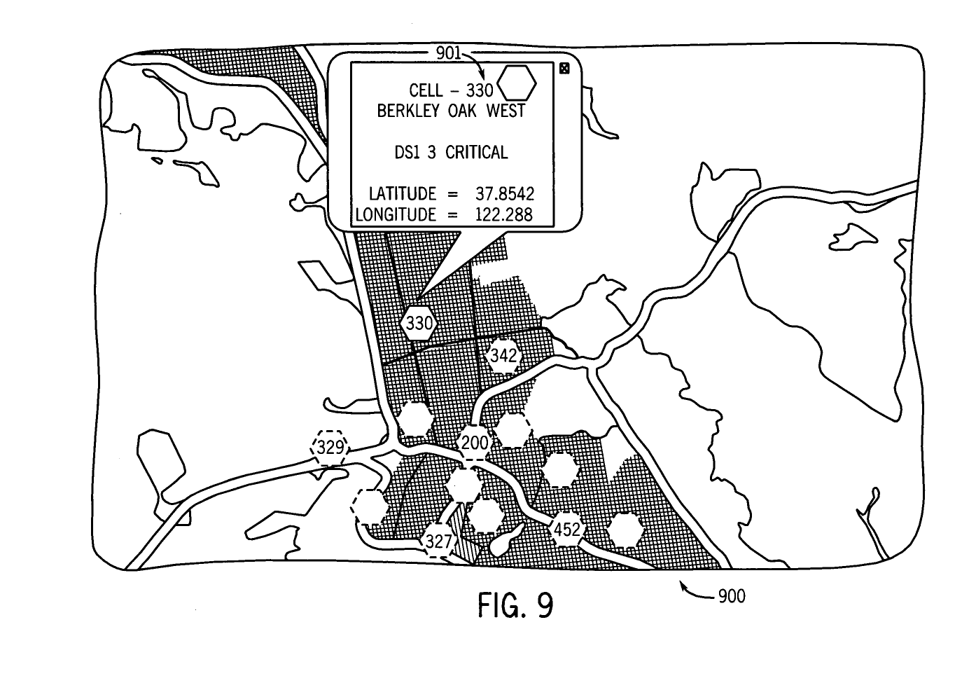

The web-based technician interface allows the technician to select any cell site with an abnormal indication to display the anomaly as in the example of FIG. 9. FIG. 9 depicts a map 900 with cell site status and a pop-up window 901.

As explained above, the known technician interface implementation requires the technician to note cell site status from several screens depending on the cell site number. The specific cell site fault is determined from additional screens that require a hierarchical “drill down” approach, such as system level to cell site level to cell site element level.

Embodiments of the present method and apparatus graphically display the cell site system level based on geographical location. The specific cell site fault(s) are displayed by simply “clicking on” the site. Graphically displaying cell sites based on their location also allows the technician to quickly realize that a specific area or cluster of cells are being affected by a common fault regardless of their cell site numbers.

It should be noted that the graphical display of the cell site fault(s) is dynamic and can be updated in real-time or near real-time. A technician can display the cell site status and receive updates as the status of the cell site changes or is updated. Additionally, the status of the cell site, as indicated in an exemplary embodiment by color, can also be changed dynamically. In this manner, not only is the status of each cell site changed in real-time or near real-time, but the data relating to the cell site status is also changed dynamically.

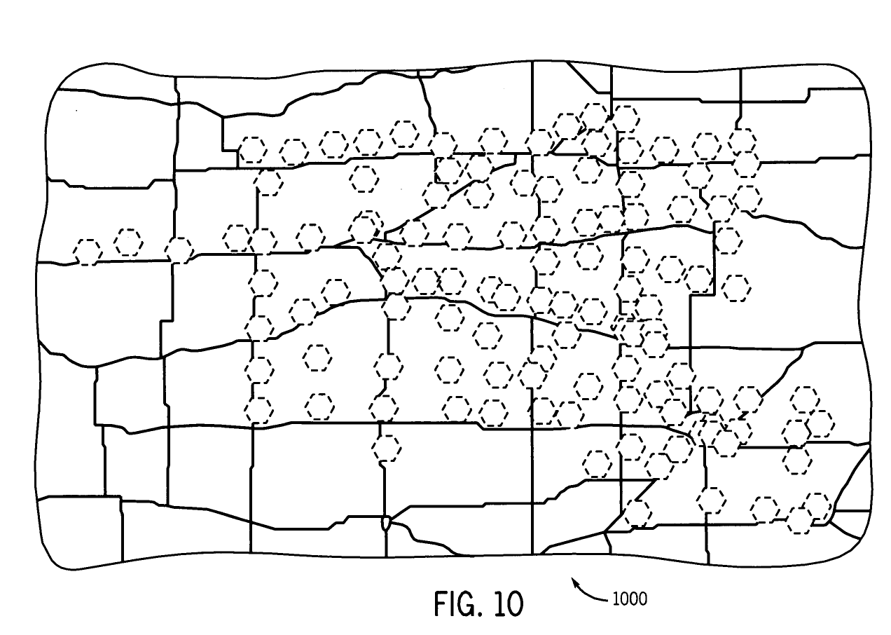

FIG. 10 depicts another map 1000 with cell site status.

Thus in general the present method and apparatus may have a plurality of cell sites, each cell site having a respective cell number; a display of all cell sites of the plurality of cell sites regardless of cell numbers. Each cell site may be displayed with a respective indicator of a plurality of indicators, the plurality of indicators having at least a first indicator that represents a normal cell site and a second indicator that indicates an abnormal cell site. The display may also have a graphical background on which the cell sites are depicted as a function of respective locations of the cell sites.

Some of the features of the present method and apparatus are as follows. A normal cell site is an operational cell site, and an abnormal cell site is one of a non-operational cell site, and a partially impaired cell site. An indicator may be at least one of a predetermined color, a flashing graphic, and a predetermined size. A respective abnormal cell site may also have a respective alarm associated therewith.

The apparatus may further comprise at least one pop-up window associated with the displayed cell sites. A respective pop-up window for a respective cell site may have predetermined information that includes at least a status of the respective cell site. The predetermined information may include at least an identification of the respective cell site, a respective alarm associated with the respective cell site, and a status of the respective cell site. A respective pop-up window for a respective cell site may have predetermined information that is indicative of an out of service condition of a respective cell site.

The graphical background may be a map on which the cell sites are depicted according to their actual geographical locations. The graphical display of cell sites may be based on their geographical location permits identification of at least one of a specific area or cluster of cells that are affected by a common fault irrespective of cell site numbers. The display of cell sites and the indicators thereof may be dynamic and may be updateable in real-time or near real-time.

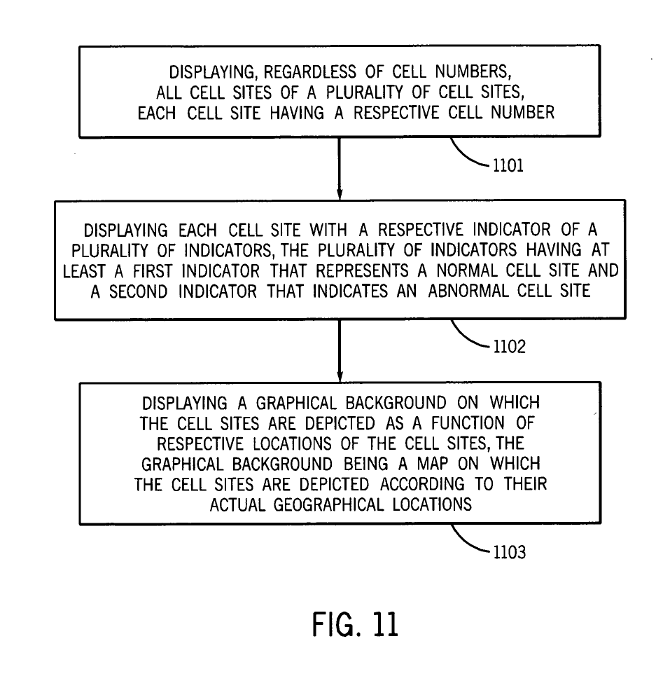

FIG. 11 is a general flow diagram depicting the present method. This embodiment of the present method has the following steps: displaying, regardless of cell numbers, all cell sites of a plurality of cell sites, each cell site having a respective cell number (step 1101); displaying each cell site with a respective indicator of a plurality of indicators, the plurality of indicators having at least a first indicator that represents a normal cell site and a second indicator that indicates an abnormal cell site (step 1102); and displaying a graphical background on which the cell sites are depicted as a function of respective locations of the cell sites, the graphical background being a map on which the cell sites are depicted according to their actual geographical locations (step 1103).

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a plurality of cell sites, each cell site having a respective cell number;
a display of all cell sites of the plurality of cell sites regardless of cell numbers;
each cell site being displayed with a respective indicator of a plurality of indicators, the plurality of indicators having at least a first indicator that represents a normal cell site and a second indicator that indicates an abnormal cell site; and
the display having a graphical background on which the cell sites are depicted as a function of respective locations of the cell sites.

2. The apparatus according to claim 1, wherein a normal cell site is an operational cell site, and wherein an abnormal cell site is one of a non-operational cell site, and a partially impaired cell site.

3. The apparatus according to claim 1, wherein an indicator is at least one of a predetermined color, a flashing graphic, and a predetermined size.

4. The apparatus according to claim 1, wherein a respective abnormal cell site has a respective alarm associated therewith.

5. The apparatus according to claim 1, wherein the apparatus further comprises at least one pop-up window associated with the displayed cell sites.

6. The apparatus according to claim 5, wherein a respective pop-up window for a respective cell site has predetermined information that includes at least a status of the respective cell site.

7. The apparatus according to claim 6, wherein the predetermined information includes at least an identification of the respective cell site, a respective alarm associated with the respective cell site, and a status of the respective cell site.

8. The apparatus according to claim 5, wherein a respective pop-up window for a respective cell site has predetermined information that is indicative of an out of service condition of a respective cell site.

9. The apparatus according to claim 1, wherein the graphical background is a map on which the cell sites are depicted according to their actual geographical locations.

10. The apparatus according to claim 9, wherein the graphical display of cell sites based on their geographical location permits identification of at least one of a specific area or cluster of cells that are affected by a common fault irrespective of cell site numbers.

11. The apparatus according to claim 1, wherein the display of cell sites and the indicators thereof is dynamic and is updateable in real-time or near real-time.

12. An apparatus, comprising:
a plurality of equipment sites of equipment that are geographically diverse;
a display of all equipment sites of the plurality of equipment sites;
each equipment site being displayed with a respective indicator of a plurality of indicators, the plurality of indicators having at least a first indicator that represents a normal equipment site and a second indicator that indicates an abnormal equipment site; and
the display having a graphical background on which the equipment sites are depicted as a function of respective locations of the equipment sites, the graphical background being a map on which the equipment sites are depicted according to their actual geographical locations.

13. The apparatus according to claim 12, wherein a normal equipment site is an operational equipment site, and wherein an abnormal equipment site is one of a non-operational equipment site, and a partially impaired equipment site.

14. The apparatus according to claim 12, wherein a respective abnormal equipment site has a respective alarm associated therewith.

15. The apparatus according to claim 12, wherein the apparatus further comprises at least one pop-up window associated with the displayed equipment sites, and wherein a respective pop-up window for a respective equipment site has predetermined information that includes at least a status of the respective equipment site.

16. The apparatus according to claim 15, wherein the predetermined information includes at least an identification of the respective equipment site, a respective alarm associated with the respective equipment site, and a status of the respective equipment site.

17. The apparatus according to claim 9, wherein the graphical display of equipment sites based on their geographical location permits identification of at least one of a specific area or cluster of equipment that are affected by a common fault.

18. The apparatus according to claim 12, wherein the equipment is at least one of telecommunication equipment, navigational aid equipment, computer networking equipment, railroad crossing signals/gates, traffic signals, and electrical power systems/grids.

19. A method, comprising:
displaying, regardless of cell numbers, all cell sites of a plurality of cell sites, each cell site having a respective cell number;
displaying each cell site with a respective indicator of a plurality of indicators, the plurality of indicators having at least a first indicator that represents a normal cell site and a second indicator that indicates an abnormal cell site; and
displaying a graphical background on which the cell sites are depicted as a function of respective locations of the cell sites, the graphical background being a map on which the cell sites are depicted according to their actual geographical locations.

20. The method according to claim 19, wherein the method further comprises providing at least one pop-up window associated with the displayed cell sites, wherein a respective pop-up window for a respective cell site has predetermined information that includes at least an identification of the respective cell site, a respective alarm associated with the respective cell site, and a status of the respective cell site, and wherein the graphical display of cell sites based on their geographical location permits identification of at least one of a specific area or cluster of cells that are affected by a common fault.
